(19) United States
(12) Patent Application Publication
(10) Pub. No.: US 2015/0158153 A1
(43) Pub. Date: Jun. 11, 2015

(54) ADJUSTABLE RATCHET WRENCH

(71) Applicant: Shwu-Ruu Chern, Taichung (TW)

(72) Inventor: Shwu-Ruu Chern, Taichung (TW)

(21) Appl. No.: 14/101,921

(22) Filed: Dec. 10, 2013

(51) Int. Cl. B25B 13/46; B25B 23/00; B25B 13/16

(52) U.S. Cl. CPC B25B 13/46; B25B 13/16; B25B 23/0028; B25B 23/0007

(57) ABSTRACT

An adjustable ratchet wrench includes a head with a handle. The head has a space defined therein and a first toothed portion is defined in an inside of the space. A first pawl is located in the head and has a first engaging portion which protrudes through a recess in the inside of the space. A hollow slide is movably located in the space and has a second toothed portion facing the first toothed portion. An index member extends from the top side of the slide. A second pawl is located in the first end of the slide and has a second engaging portion facing the space. A threaded rod extends through the slide which has pins engaged with outer threads of the threaded rod. By rotating the threaded rod, the slide with the second pawl move into the space to clamp objects of different sizes.

### BACKGROUND OF THE INVENTION

1. Fields of the Invention

The present invention relates to a ratchet wrench, and more particularly, to a ratchet wrench wherein the clamp distance can be adjustable.

2. Descriptions of Related Art

There are many different types of conventional ratchet wrenches which are designed to tighten or loose an object. However, the objects to be tightened or loosened have different sizes and the clamp distance of the conventional ratchet wrenches cannot be quickly adjusted.

The present invention intends to provide a ratchet wrench whose clamp distance can he adjusted to as to improve the shortcomings mentioned above.

### SUMMARY OF THE INVENTION

The present invention relates to an adjustable ratchet wrench and comprise a head and a handle is connected to the connection end of the head. A space is defined in the head and a first toothed portion is defined in the inside of the first inner end of the space. A recess is defined in the inside of the first inner end of the space and a first reception hole is defined in the inside of the second inner end of the space. A first pawl is pivotably located in the space and has a first engaging portion by a first pin. The first engaging portion protrudes through the recess in the inside of the first inner end of the space and is located in the space. A positioning unit is located between the first pawl and the inside of the recess in the head so as to bias the first pawl toward the space.

A hollow slide is located in the space and has a second toothed portion defined in the first end thereof. The second toothed portion faces the first toothed portion. An end hole is defined in the second end of the slide. Multiple through holes are defined through the wall of three sides of the second end of the slide and each through hole has a pin inserted therein. An index member extends from the top side of the second end of the slide.

A second pawl is pivotably located in a recess defined in the first end of the slide by a second pin and the second pawl has a second engaging portion which protrudes from the first end of the slide and faces the space. Another positioning unit is located between the inside of the recess in the first end of the slide and the second pawl to bias the second pawl toward the space.

A threaded rod extends through the reception hole and is located in the slide. The threaded rod has outer threads and an engaging section. The pins extending through the walls of the slide contact the outer threads. The engaging section is connected with a knob. A second reception hole is defined in one end of the threaded rod. A resilient member is biased between two respective inner ends of the first and second reception holes.

A cover is fixed to the top of the head and has a slot defined therethrough. The index member extends through the slot. Multiple marks are marked on the cover along one side of the slot.

Preferably, each of the positioning units comprises a spring and a positioning member.

Preferably, the resilient member is a spring.

Preferably, the engaging section of the threaded rod and the knob are integrally formed with each other.

Preferably, an angle-adjustment unit is connected between the head and the handle.

Preferably, the angle-adjustment unit comprises a rod, a spring and an engaging member. The head has a toothed member connected to the connection end thereof. The spring and the rod are located in the handle, and the rod is biased by the spring. The rod has a notch. The engaging member is engaged with the toothed member and engaged with the notch of the rod to position angular position of the handle relative to the head.

The primary object of the present invention is to provide an adjustable ratchet wrench which is able to easily clamp objects of different sizes.

Another object of the present invention is to provide, an adjustable ratchet wrench wherein the user is acknowledged the size of the object that is clamped by the wrench.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the adjustable ratchet wrench of the present invent ion;

FIG. 2 is an exploded view of the adjustable ratchet wrench of the present invention from another angle;

FIG. 3 is a perspective view to show the adjustable ratchet wrench of the present invention;

FIG. 4 is a perspective view to show the adjustable ratchet wrench of the present invention from another angle;

FIG. 5 is a bottom view of the adjustable ratchet wrench of the present invention;

FIG. 6 is a top view of the adjustable ratchet wrench of the present invention;

FIG. 7 is a cross sectional view taken along line 6-6 in FIG. 6;

FIG. 8 is a cross sectional view of the adjustable ratchet wrench of the present invention;

FIG. 9 is a side view of the adjustable ratchet wrench of the present invention, and

FIG. 10 is a cross sectional view taken along line 9-9 in FIG. 9.

### DETAILED DESCRIPTION OF THE PREFERRED EMBODIMENT

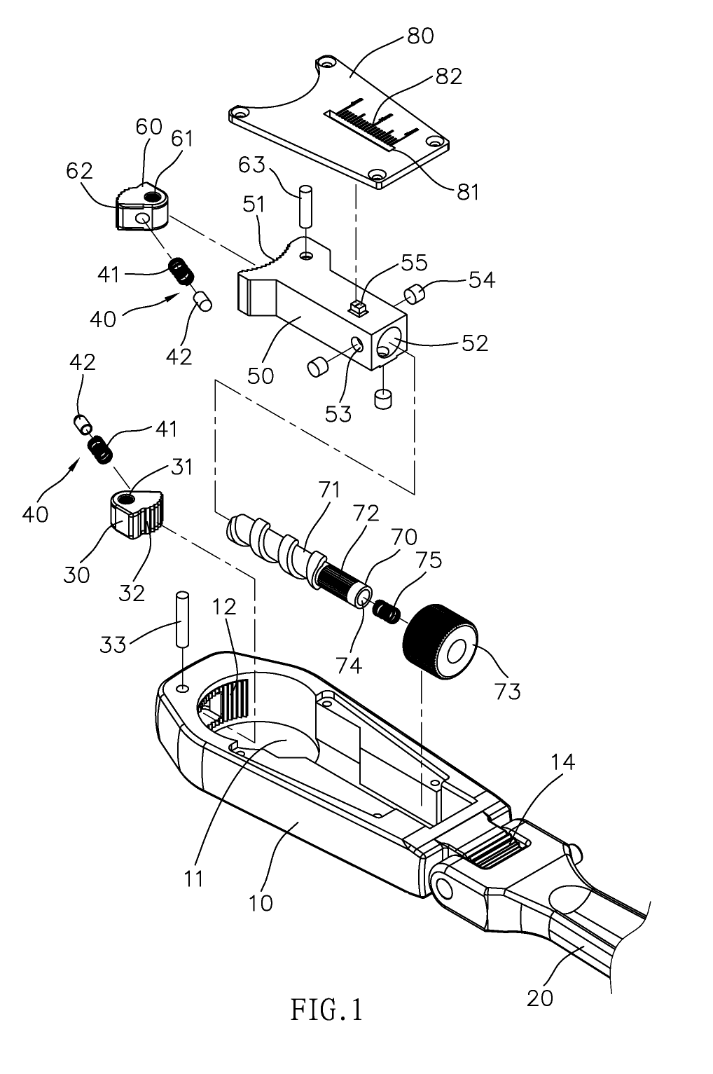

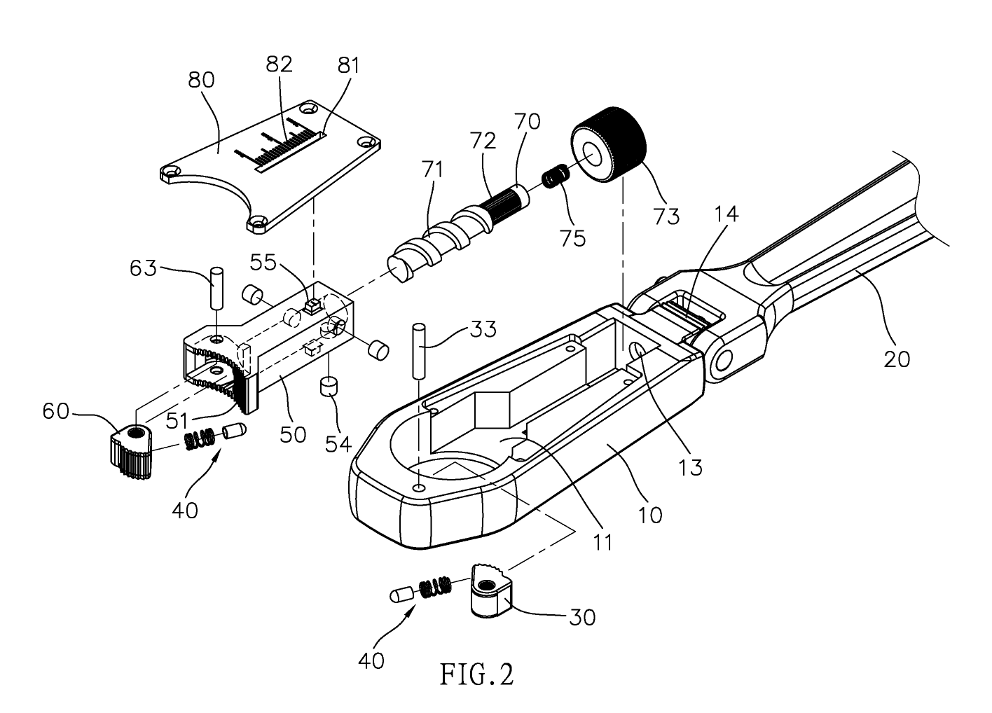

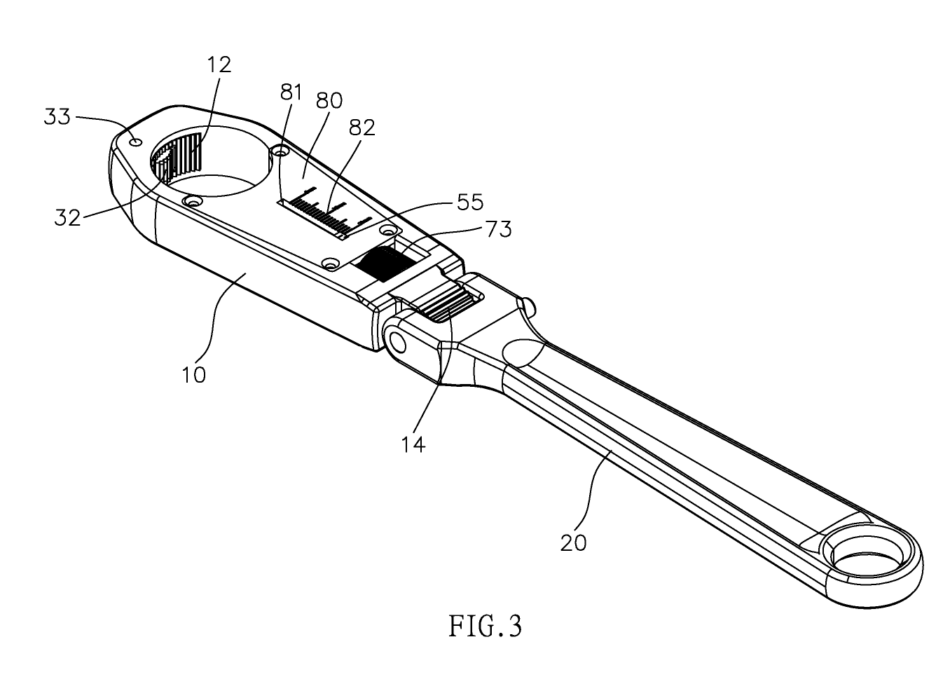

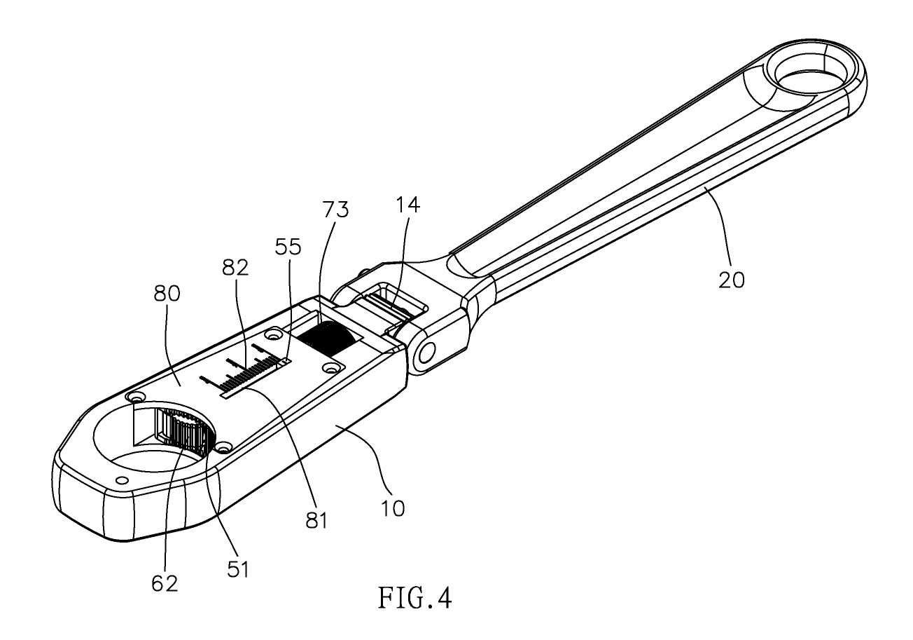

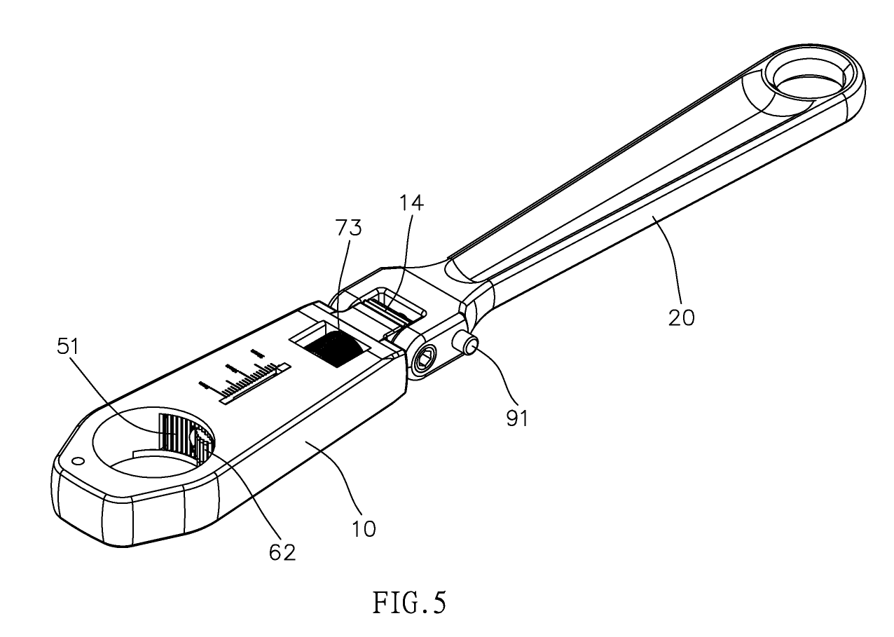

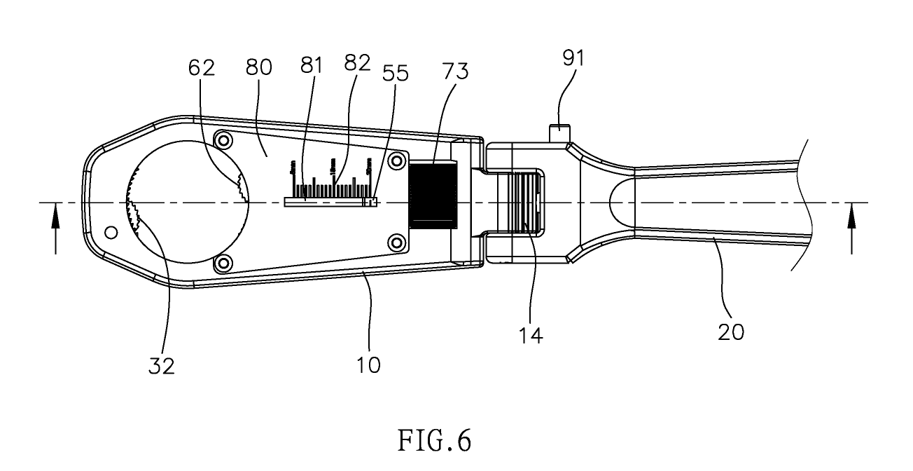

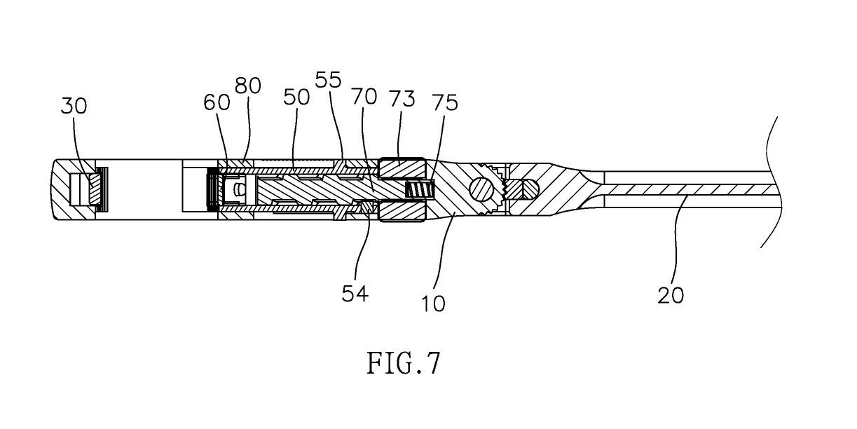

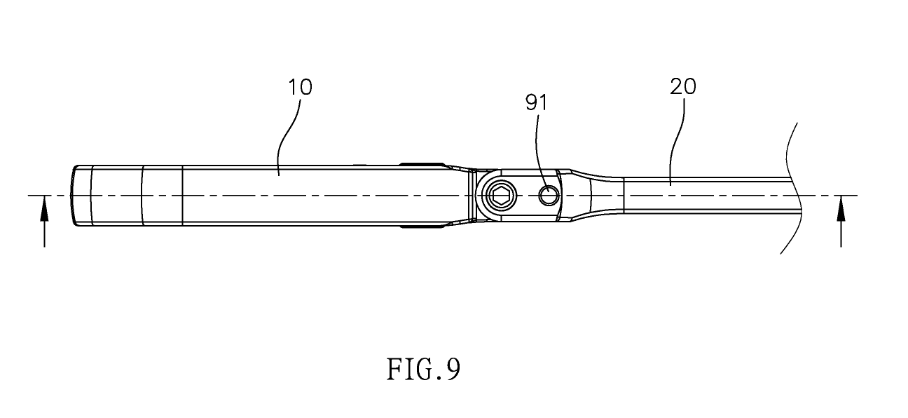

Referring to FIGS. 1 to 10, the adjustable ratchet wrench of the present invention comprises a head 10 and a handle 20 is connected to the connection end of the head 10. A space 11 is defined in the head 10 and a first toothed portion 12 is defined in the inside of the first inner end of the space 11. A recess is defined in the inside of the first inner end of the space 11. A first reception hole 13 is defined in the inside of the second inner end of the space 11.

A first pawl 30 is located in the space 11 and has a first engaging portion 32. A first pin 33 extends through a first hole 31 in the first pawl 30 to pivotably position the first pawl 30 in the head 10. The first engaging portion 32 protrudes through the recess in the inside of the first inner end of the space 11 and is located in the space 11. A positioning unit 40 is located between the first pawl 30 and the inside of the recess in the head 10 so as to bias the first pawl 30 toward the space 11.

A hollow slide 50 is located in the space 11 and has a second toothed portion 51 defined in the first end thereof. The second toothed portion 51 faces the first toothed portion 12. An end hole 52 is defined in the second end of the slide 50. Multiple through holes 53 are defined through the wall of three sides of the second end of the slide 50 and each through hole 53 has a pin 54 inserted therein. An index member 55 extends from the top side of the second end of the slide 50.

A second pawl 60 is pivotably located in a recess defined in the first end of the slide 50 by extending a second pin 63 through a second hole 61 defined in the second pawl 60. The second pawl 60 has a second engaging portion 62 which protrudes from the first end of the slide 50 and faces the space 11. Another positioning unit 40 is located between the inside of the recess in the first end of the slide 50 and the second pawl 60 to bias the second pawl 60 toward the space 11. Each of the positioning units 40 comprises a spring 41 and a positioning member 42.

A threaded rod 70 extends through the reception hole 52 and located in the slide 50. The threaded rod 70 has outer threads 71 and an engaging section 72. The pins 54 extending through the slide 50 contact the outer threads 71. The engaging section 72 is connected with a knob 73. The knob 73 is accessible from outside of the head 10. A second reception hole 74 is defined in an end of the threaded rod 70, and a resilient member 75 is biased. between two respective inner ends of the first and second reception holes 13, 74. The resilient member 75 is a spring. The engaging section 72 of the threaded rod 70 and the knob 73 can be integrally formed with each other.

A cover 80 is fixed to the top of the head 10 and has a slot 81 defined therethrough. The index member 55 extends through the slot 81. Multiple marks 82 are marked on the cover 80 along one side of the slot 81.

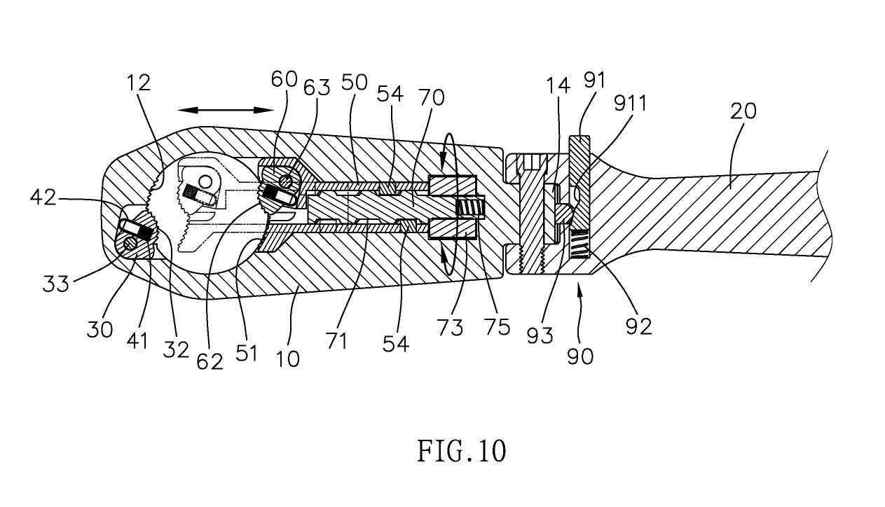

An angle-adjustment unit 90 is connected between the head 10 and the handle 20, wherein the angle-adjustment unit 90 comprises a rod 91, a spring 92 and an engaging member 93. The head 10 has a toothed member 14 connected to the connection end thereof. The spring 92 and the rod 91 are transversely located in the handle 20, and the rod 91 is biased by the spring 92. An end of the rod 91 protrudes from one side of the handle 20 such that the user can push the rod 91 downward into the handle 20. The rod 91 has a notch 911. The engaging member 93 engaged with the toothed member 14 and engaged with the notch 911 of the rod 91 to position angular position of the handle 20 relative to the head 10 as shown in FIG. 10.

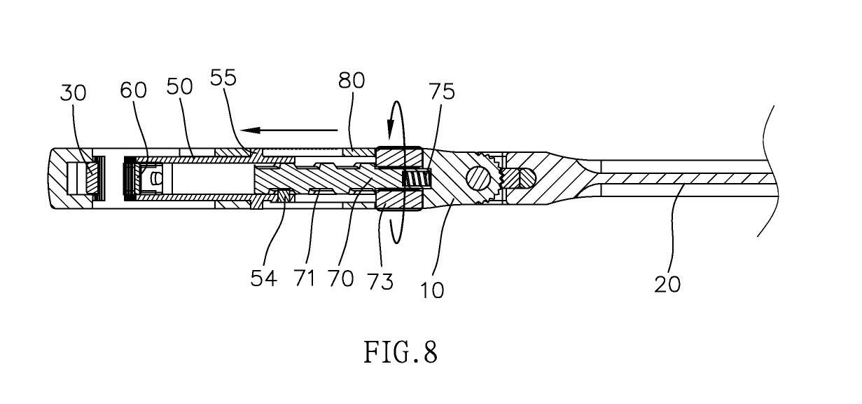

When in use, the object (not shown) to be tightened or loosened is located in the space 11 of the head 10 and the user rotates the knob 73 so that the threaded rod 70 is rotated. Because the pins 54 of the slide 50 contact the outer threads 71 of the threaded rod 70, so that the slide 50 moves toward the object until the second toothed portion 51 of the slide 50 contact the object. The first engaging portion 32 of the first pawl 30, the second engaging portion 62 of the second pawl 60 and the second toothed portion 51 of the slide 50 together clamp the object as shown in FIGS. 8 and 10 to as to tighten or loosen the object.

Because there are marks 82 on the top of the cover $0, the user is acknowledged the size of the object by checking the mark 82 in alignment with the index member 55 that is moved along the slot 81.

The outer threads 71 are designed such that when the threaded rod 70 is rotated one revolution, the slide 50 moves . significant distance so as to quickly move the slide 50 to contact the object. The slide 50 moves 5 to 10 times faster than that of the conventional wrenches.

The marks 82 can also be marked on the bottom of the cover 80 so that the user can easily check the marks 82 from different positions.

While we have shown and described the embodiment in accordance with the present invention, it should be clear to those skilled in the art that further embodiments may be made without departing from the scope of the present invention.

What is claimed is:

1. An adjustable ratchet wrench comprising:
a head, a handle connected to a connection end of the head, a space defined in the head and a first toothed portion defined in an inside of a first inner end of the space, a recess defined in the inside of the first inner end of the space, a first reception hole defined in an inside of a second inner end of the space;
a first pawl located in the space and having a first engaging portion, a first pin extending through a first hole in the first pawl to pivotably position the first pawl in the head, the first engaging portion protruding through the recess in the inside of the first inner end of the space and located in the space, a positioning unit located between the first pawl and an inside of the recess in the head so as to bias the first pawl toward the space;
a hollow slide located in the space and having a second toothed portion defined in a first end thereof, the second toothed portion facing the first toothed portion, an end hole defined in a second end of the slide, multiple through holes defined through a wall of three sides of the second end of the slide and each through hole having a pin inserted therein, an index member extending from a top side of the second end of the slide;
a second pawl pivotably located in a recess defined in the first end of the slide by extending a second pin through a second hole defined in the second pawl, the second pawl having a second engaging portion which protrudes from the first end of the slide and faces the space, another positioning unit located between an inside of the recess in the first end of the slide and the second pawl to bias the second pawl toward the space;
a threaded rod extending through the reception hole and located in the slide, the threaded rod having outer threads and an engaging section, the pins extending through the slide contacting the outer threads, the engaging section connected with a knob, a second reception hole defined in an end of the threaded rod, a resilient member being biased between two respective inner ends of the first and second reception holes, and
a cover fixed to a top of the head and having a slot defined therethrough, the index member extending through the slot, multiple marks being marked on the cover along one side of the slot.

2. The wrench as claimed in claim 1, wherein each of the positioning units comprises a spring and a positioning member.

3. The wrench as claimed in claim 1, wherein the resilient member is a spring.

4. The wrench as claimed in claim 1, wherein the engaging section of the threaded rod and the knob are integrally formed with each other.

5. The wrench as claimed in claim 1, wherein an angle-adjustment unit is connected between the head and the handle.

6. The wrench as claimed in claim 5, wherein the angle-adjustment unit comprises a rod, a spring and an engaging member, the head has a toothed member connected to the connection end thereof, the spring and the rod are located in the handle and the rod is biased by the spring, the rod has a notch, the engaging member engaged with the toothed member and engaged with the notch of the rod to position angular position of the handle relative to the head.
